(19) United States
(12) Patent Application Publication
(10) Pub. No.: US 2008/0254316 A1
(43) Pub. Date: Oct. 16, 2008

(54) Plain-Bearing Material, Plain-Bearing Composite-Material and Uses Thereof

(76) Inventors: Udo Roos, Homberg (DE); Erik Kraft, Stadtallendorf (DE); Thilo Koch, Duderstadt (DE)

Correspondence Address: Robert L Stearns, Dickinson Wright, 38525 Woodward Avenue, Bloomfield Hills, MI, 48304-2970, US

(21) Appl. No.: 10/592,330

(22) PCT Filed: Feb. 11, 2005
(86) PCT No.: PCT/DE05/00252

§ 371 Date: Jun. 19, 2007

(30) Foreign Application Priority Data
Mar. 11, 2004 (DE) 10 2004 011 831.0

(51) Int. Cl. B32B 15/20

(52) U.S. Cl. 428/674

(57) ABSTRACT

The invention relates to a sintered plain bearing material consisting of a copper alloy, which is characterized by between 10 and 15 wt. % tin, between 0.5 and 10 wt. % bismuth, between 5 and 12 wt. % graphite and a residual amount of copper. Said plain bearing material can also be applied to a support material consisting of steel and/or bronze. Said plain bearing material is used for radial or axial plain bearings, plain bearing segments, sliding plates, spherical plain bearings and/or bearing bushes.

The invention relates to a sintered plain-bearing material consisting of a copper alloy. The invention also concerns a plain-bearing composite material as well as uses for the plain-bearing material and/or plain-bearing composite material.

For the manufacture of plain-bearings according to a requirements profile, aluminum or copper alloys, among others, are used, along with appropriate additional components. Lead is added as a softening component in order to improve the ease of embedment.

For dry operation applications with small sliding velocity, copper-tin-lead alloys with graphite components are used. In view of the toxic properties of lead, substitute materials are sought for, which do not give up the previously achieved advantages of the plain-bearing materials.

To take remedial action here, in EP 0 224 619 A1 it is proposed for oil-lubricated bearing shells in internal combustion engines, that the lead component in copper alloys be reduced or totally eliminated and bismuth be used, instead. In load tests with copper-lead and copper-bismuth bearings having comparable volumes of lead and bismuth, an improvement could actually be ascertained in favor of the copper-bismuth alloy.

Hence in EP 0 224 619 A1, in particular also for the improvement of corrosion resistance, a bismuth content of 5 to 25% by weight is designated, wherein up to 10% by weight tin, up to 1% by weight lead, as well as silver, antimony, tin, phosphorus, or nickel can be additionally contained.

These alloys, which are sintered on steel backs, can be cast or rolled and display the best properties if they have 12 to 18% by weight bismuth, 1 to 3% tin and 0.5% lead. With omission of lead, a bismuth content even in the range of 12 to 20% by weight and tin content of 1 to 2% by weight is disclosed.

In view of the large proportion of bismuth and the high costs associated therewith, the desire exists to find economical plain-bearing material with retention of the positive properties.

This problem is solved with a sintered plain-bearing material which is characterized by 10 to 15% by weight tin, 0.5 to 10% by weight bismuth, 5 to 12% by weight graphite and the remainder copper.

According to the invention, the solution is based upon the surprising result that the bismuth content can be significantly lowered, if graphite is added and the tin content is increased. Since tin and graphite are more economical than bismuth, by means of the invention the costs for the manufacture of the plain-bearing material can be decidedly lowered. Moreover, lead, which was required according to the prior art even with the smallest bismuth content, can be omitted. Consequently, an economical lead-free material is created, which has clearly better tribological properties.

By reduction of the bismuth content and a raising of the tin- and graphite content, the matrix fraction, namely, which is of copper, remains to a large extent unchanged, which entails the advantage that the solidity remains unchanged, in contrast to known plain-bearing materials with higher bismuth contents. Here, the tin content always is higher than the bismuth content.

It is preferred, to adjust the bismuth content to under 5%, i.e. to 0.8 to <5% by weight.

Another preferred bismuth range is from 8 to 10% by weight.

The tin content is preferably at >10 to 13% by weight and is especially preferred at 11 to 13% by weight.

It has been shown that the addition of graphite has the advantage that resistance to wear can, in fact, be further increased.

Natural graphite is preferably used for the graphite portion. It is also possible to use synthetic graphite.

Preferably the graphite has a grain size range with 99% of same having a grain size <40 μm. This graphite is known as f-graphite and is particularly advantageous, if a sliding layer provided with the plain-bearing material is exposed to the micro-movements.

When there are spacious sliding movements, the so-called p-graphite is preferred, which has a grain size of 100 to 600 μm. A preferred grain size range is 100 to 300 μm. This graphite is designated as pf-graphite.

The plain-bearing material can be made from solid material. In this case, it is advantageous if the plain-bearing material contains sintering auxiliaries. As sintering auxiliaries, from 1 to 3% by weight MoS₂ and/or 0.5 to 2% by weight CuP are suitable and preferred.

The plain-bearing material, for example, can be introduced onto a support material made from steel or bronze. In this case, we have a plain-bearing composite material wherein the plain bearing material is sintered on a support material. A sintering auxiliary is not added to the plain bearing material in this embodiment.

Preferably, the plain-bearing material and/or composite material is used for non-lubricated bearings. A further preferred application is usage for journal bearings, plain thrust bearings, plain or sliding bearing-segments, sliding plates, ball-and-socket joints and/or bearing bushes or shells.

Further preferred fields of application include off-shore technology; the energy industry; energy transformation plants; hydro-electric power generation; shipbuilding; transportation facilities; the steel industry (i.e. crude iron production; rolling mills); synthetic material processing machines; steel-/hydraulic engineering; the automobile industry; rubber processing; materials handling; furnace and baking oven construction.

Exemplary embodiments are illustrated by means of the following figures.

They are:

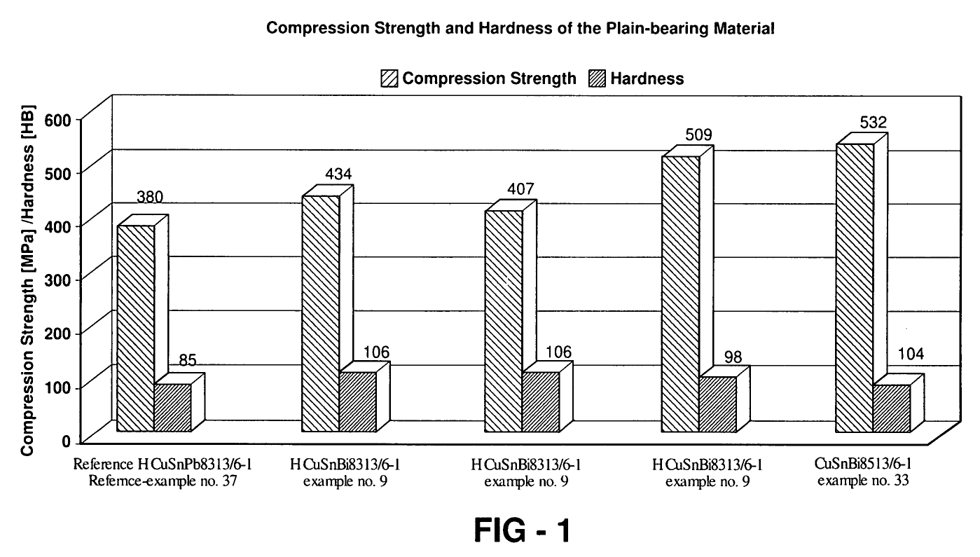

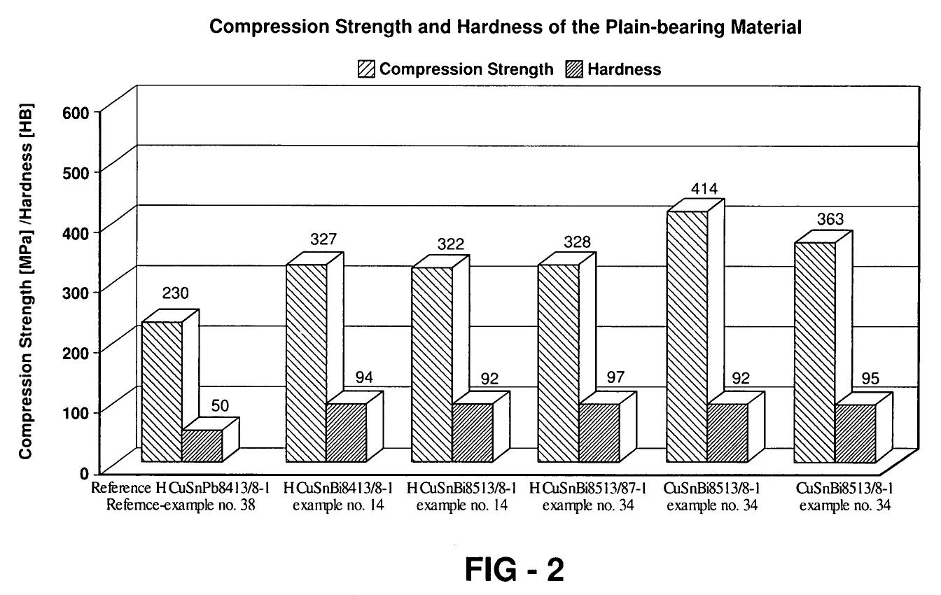

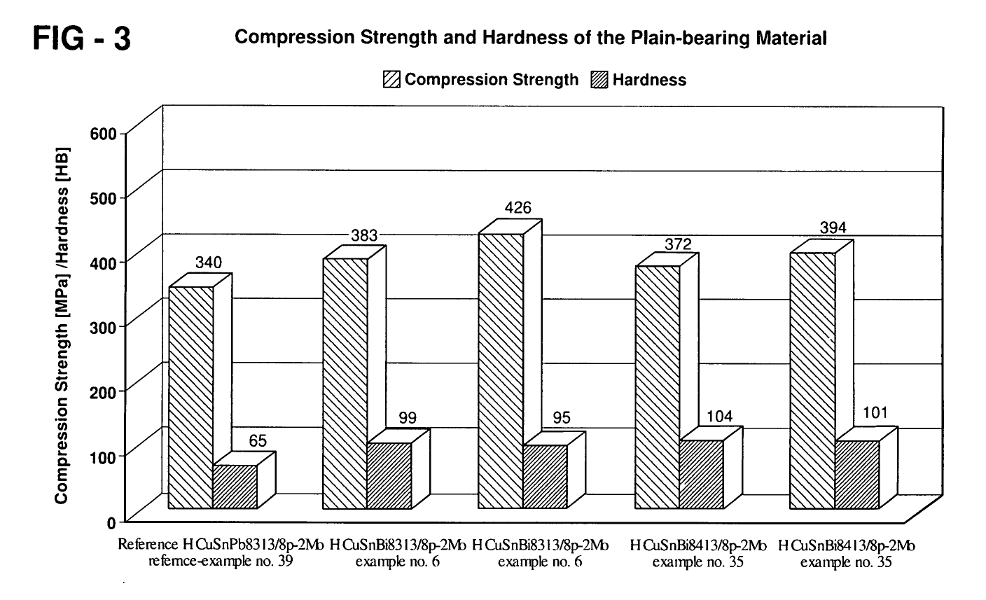

FIGS. 1-3 compressive strength- and hardness diagrams,

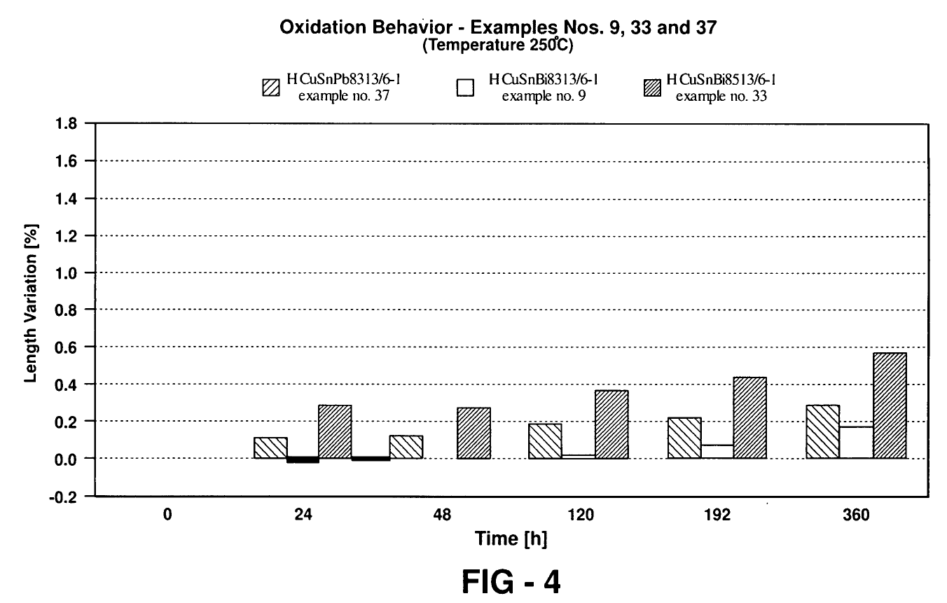

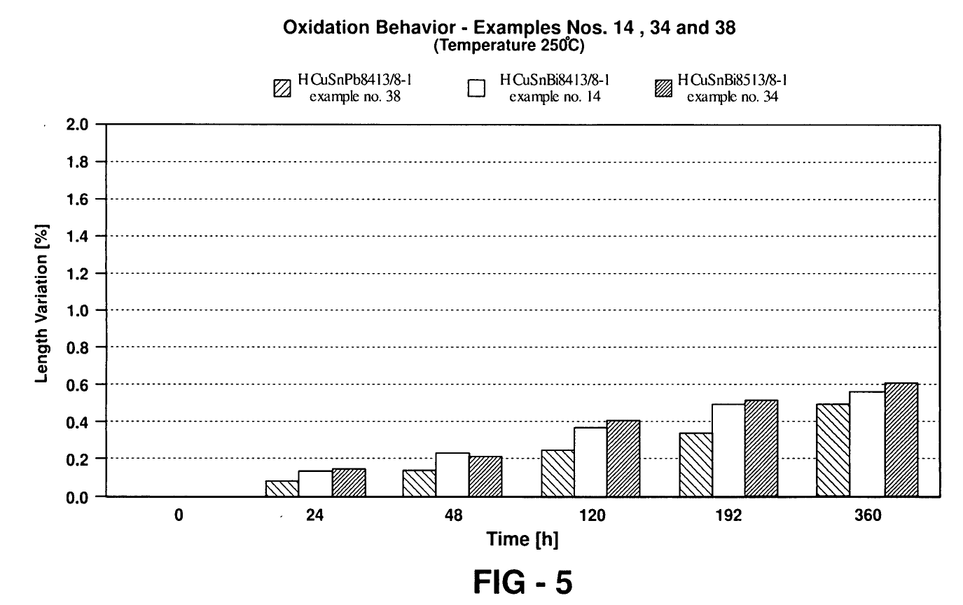

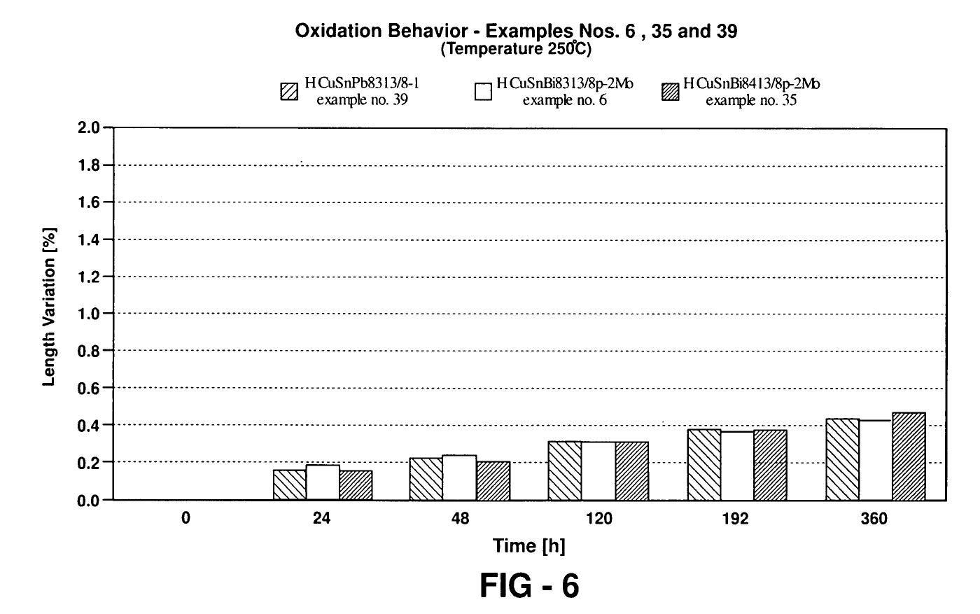

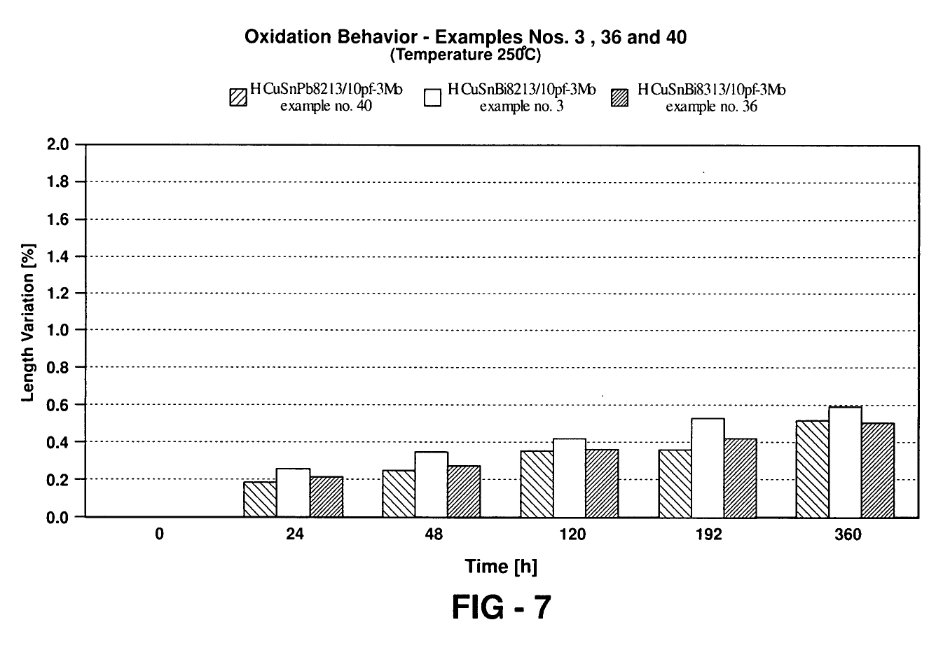

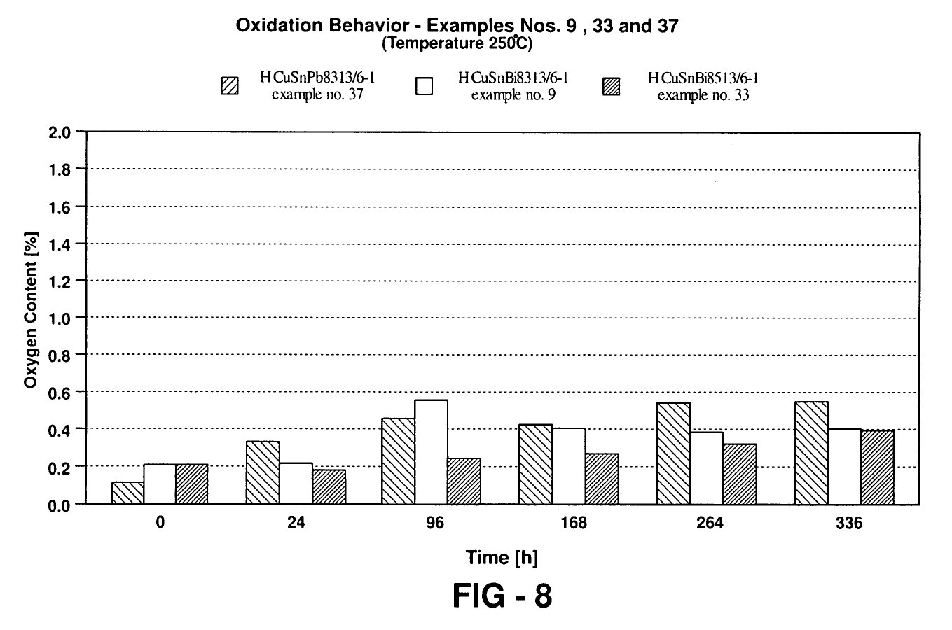

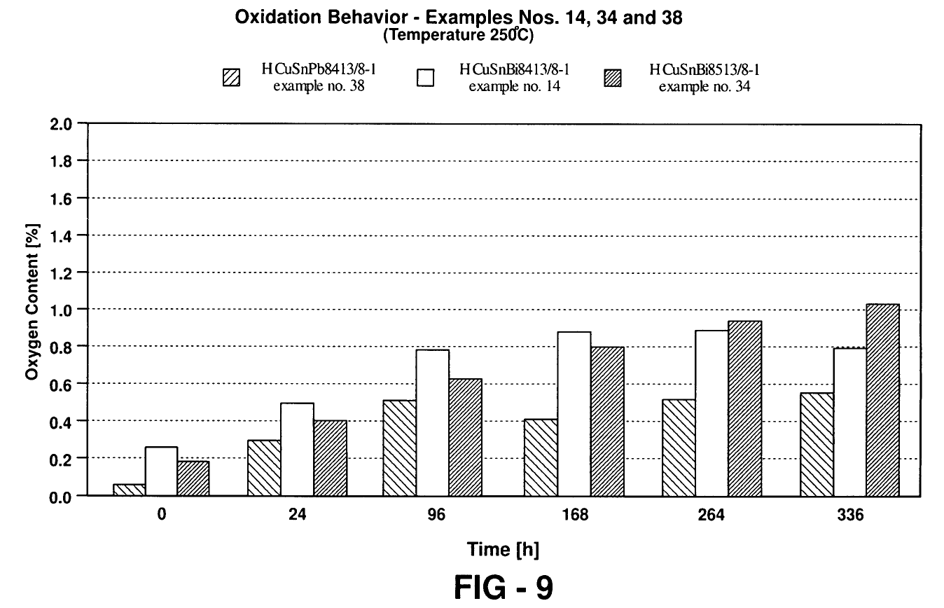

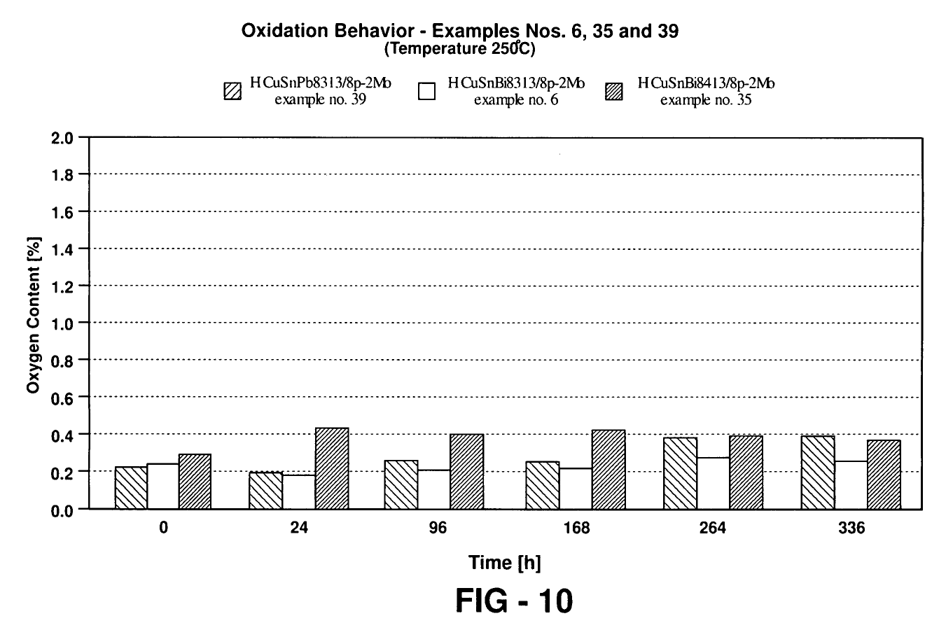

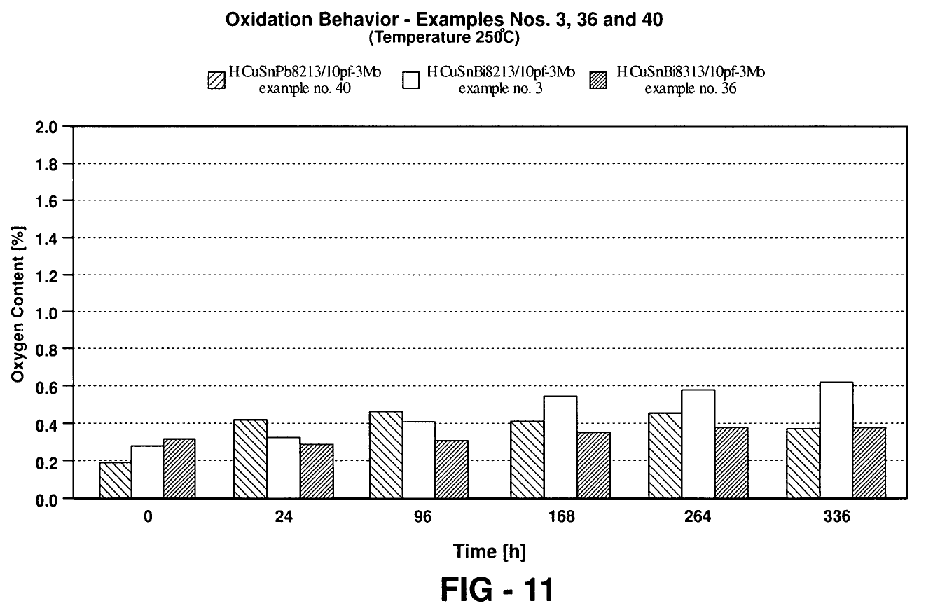

FIGS. 4-11 diagrams of the oxidation properties,

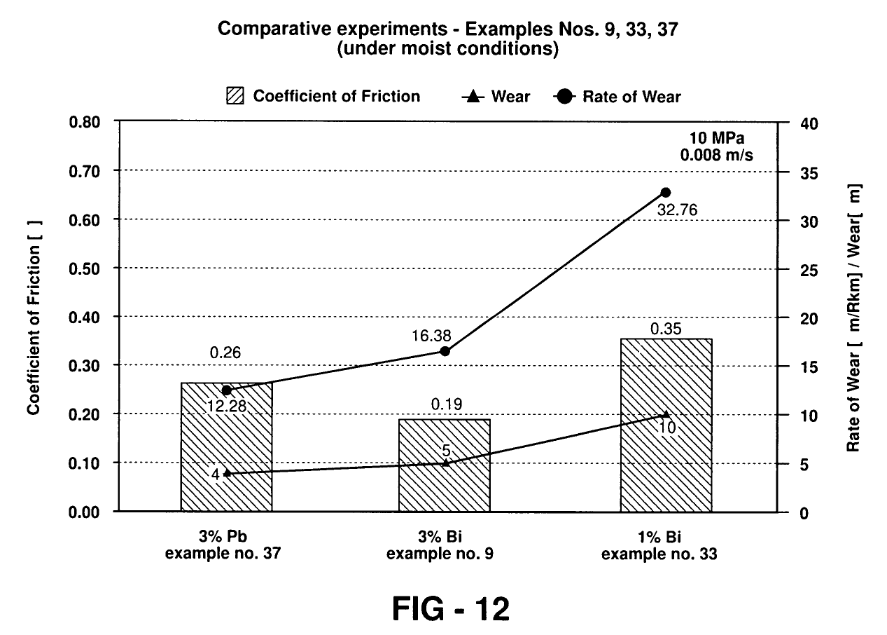

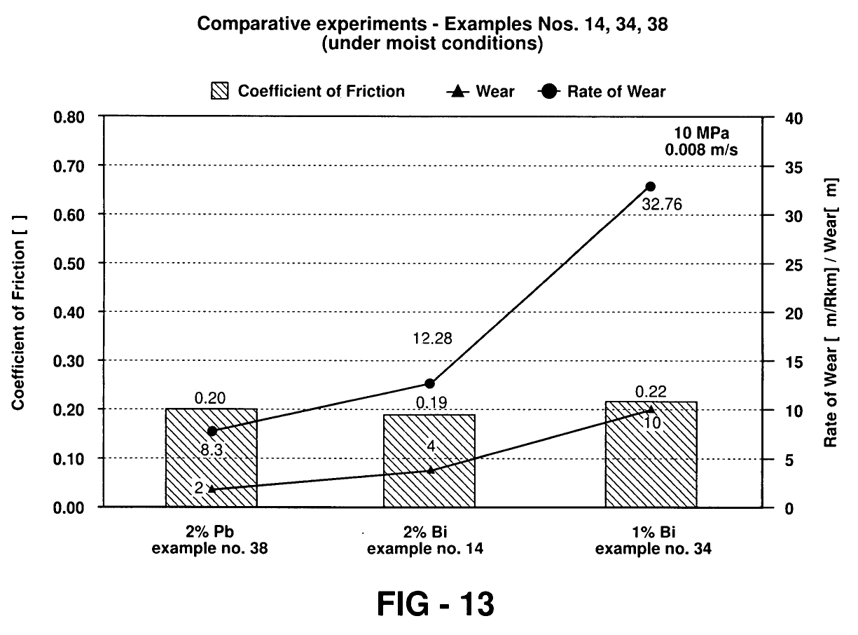

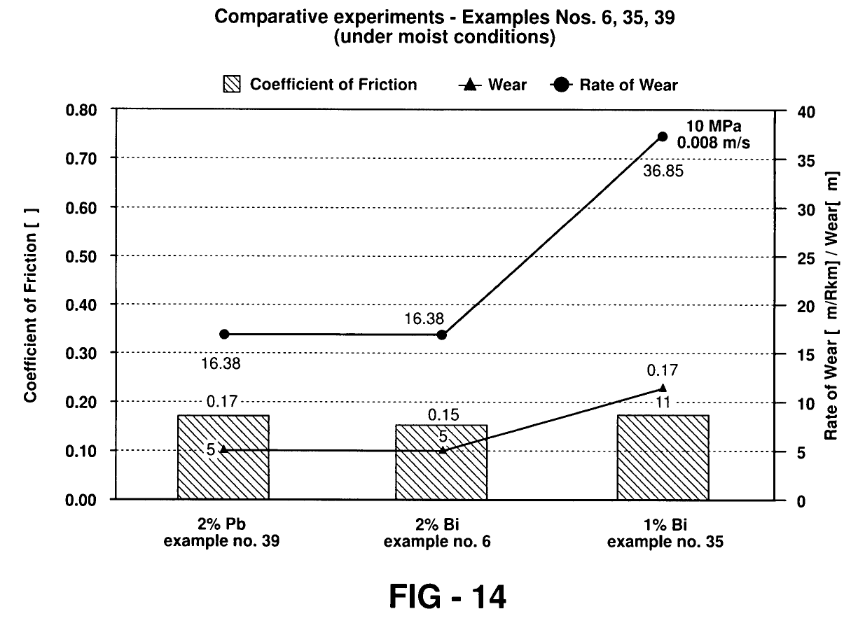

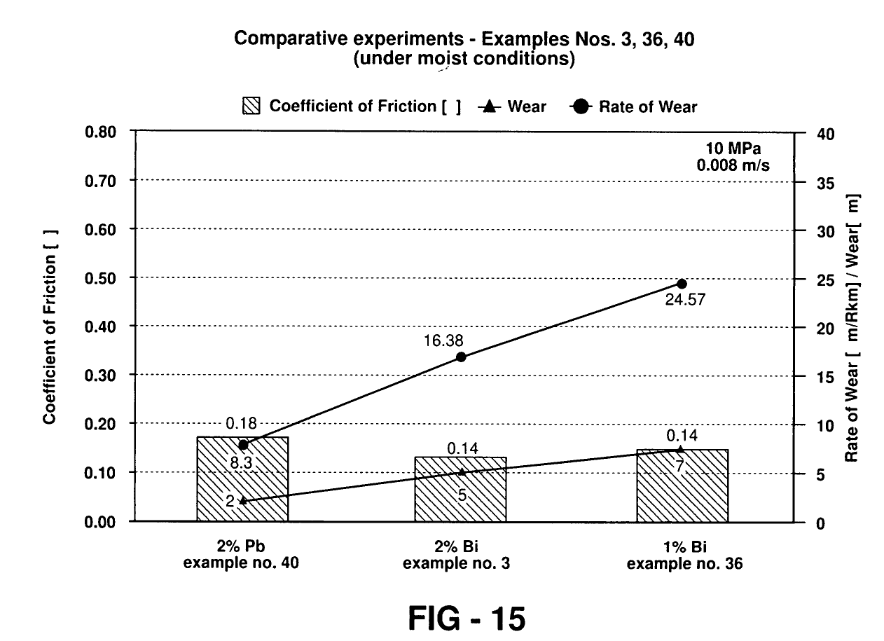

FIGS. 12-15 diagrams for the friction coefficients, wear and wear rate,

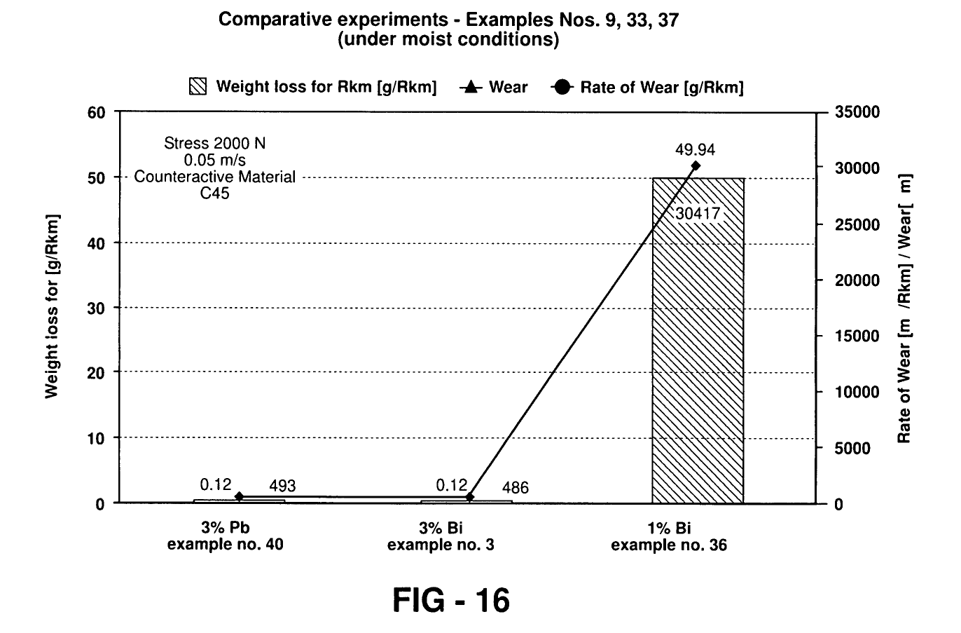

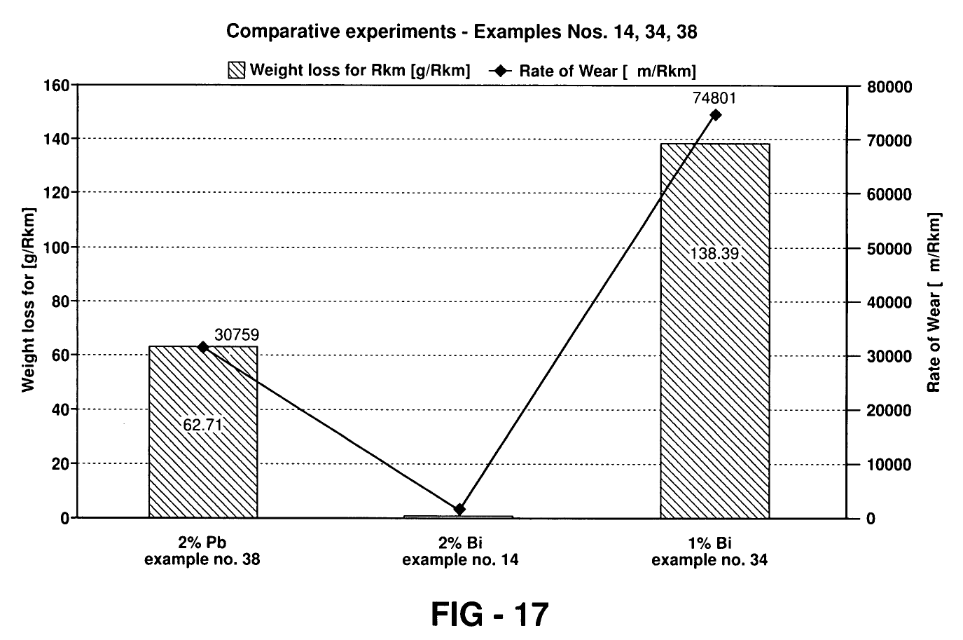

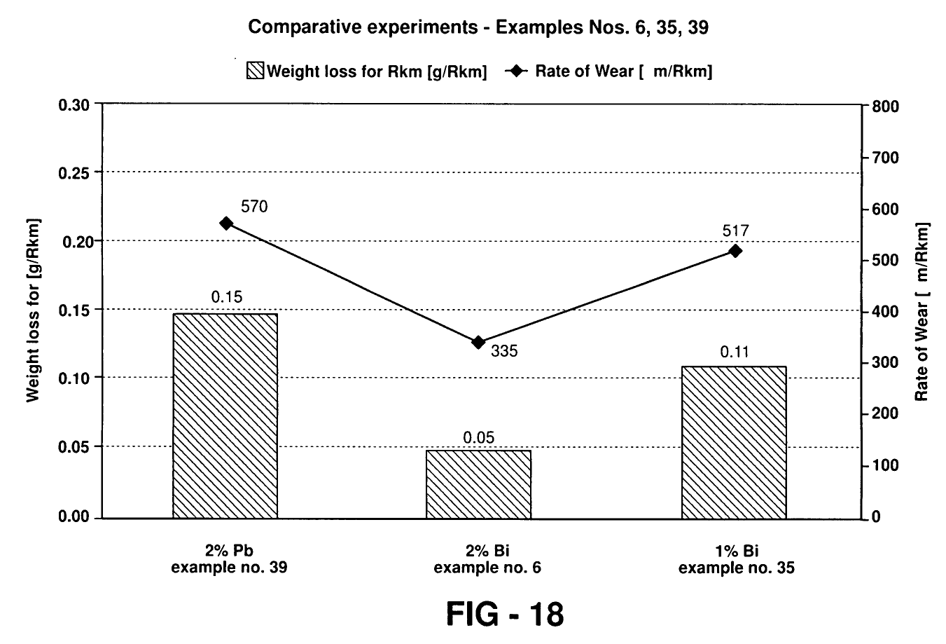

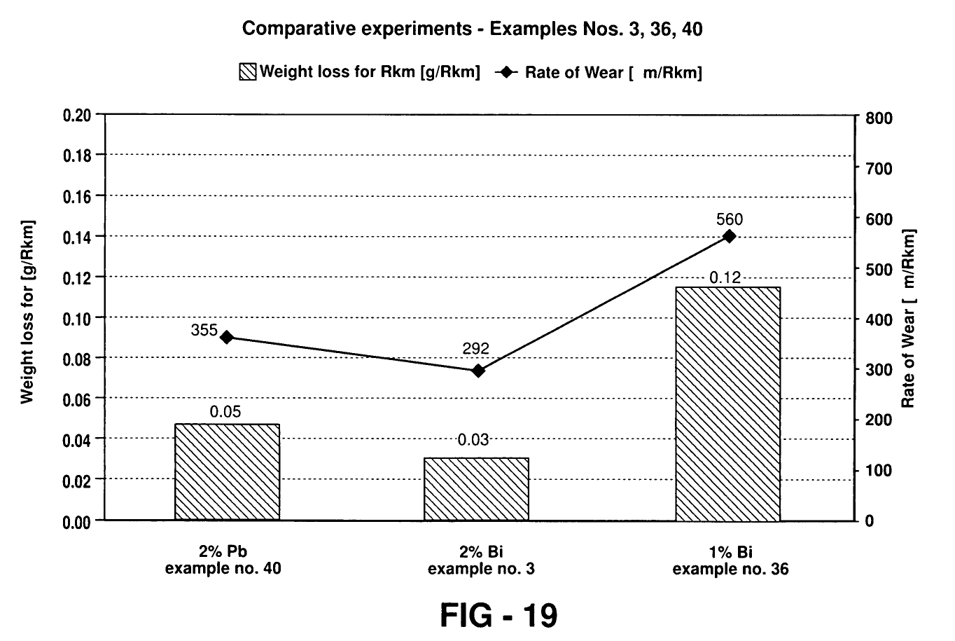

FIGS. 16-19 diagrams for abrasion.

In table 1 below, preferred compositions of the plain-bearing material are given.

TABLE 1
(all data is in weight percent)

| Example | | | | | | | |
|---|---|---|---|---|---|---|---|
| No. | Cu | Sn | Bi | MoS₂ | CuP | Graphite | Total |
| 1 | 77.36 | 12.26 | 1.89 | 2.83 | 0.00 | 5.66 | 100 |
| 2 | 75.93 | 12.04 | 1.85 | 2.78 | 0.00 | 7.41 | 100 |
| 3 | 74.55 | 11.82 | 1.82 | 2.73 | 0.00 | 9.09 | 100 |
| 4 | 73.21 | 11.61 | 1.79 | 2.68 | 0.00 | 10.71 | 100 |
| 5 | 78.30 | 12.25 | 1.89 | 1.89 | 0.00 | 5.66 | 100 |
| 6 | 76.85 | 12.04 | 1.85 | 1.85 | 0.00 | 7.41 | 100 |
| 7 | 75.45 | 11.82 | 1.82 | 1.82 | 0.00 | 9.09 | 100 |
| 8 | 74.11 | 11.61 | 1.79 | 1.79 | 0.00 | 10.71 | 100 |
| 9 | 78.30 | 12.26 | 2.83 | 0.00 | 0.94 | 5.66 | 100 |
| 10 | 76.85 | 12.04 | 2.78 | 0.00 | 0.93 | 7.41 | 100 |
| 11 | 75.45 | 11.82 | 2.73 | 0.00 | 0.91 | 9.09 | 100 |
| 12 | 74.11 | 11.61 | 2.68 | 0.00 | 0.89 | 10.71 | 100 |
| 13 | 79.25 | 12.26 | 1.89 | 0.00 | 0.94 | 5.66 | 100 |
| 14 | 77.78 | 12.04 | 1.85 | 0.00 | 0.93 | 7.41 | 100 |
| 15 | 76.36 | 11.82 | 1.82 | 0.00 | 0.91 | 9.09 | 100 |
| 16 | 775.00 | 11.61 | 1.79 | 0.00 | 0.89 | 10.71 | 100 |
| 17 | 79.25 | 12.26 | .94 | 0.00 | 1.89 | 5.66 | 100 |
| 18 | 77.78 | 12.04 | 0.93 | 0.00 | 1.85 | 7.41 | 100 |
| 19 | 76.36 | 11.82 | .0.91 | 0.00 | 1.82 | 9.09 | 100 |
| 20 | 75.00 | 11.81 | 0.89 | 0.00 | 1.79 | 10.71 | 100 |
| 21 | 71.70 | 12.26 | 8.49 | 1.89 | 0.00 | 5.66 | 100 |
| 22 | 70.37 | 12.04 | 8.33 | 1.85 | 0.00 | 7.41 | 100 |
| 23 | 89.09 | 11.82 | 8.18 | 1.82 | 0.00 | 9.09 | 100 |
| 24 | 67.86 | 11.61 | 8.04 | 1.79 | 0.00 | 10.71 | 100 |
| 25 | 71.70 | 12.26 | 9.43 | 0.00 | 0.94 | 5.66 | 100 |
| 26 | 70.37 | 12.04 | 9.26 | 0.00 | 0.93 | 7.41 | 100 |
| 27 | 89.09 | 11.82 | 9.09 | 0.00 | 0.91 | 9.09 | 100 |
| 28 | 67.86 | 11.61 | 8.93 | 0.00 | 0.89 | 10.71 | 100 |
| 29 | 77.36 | 12.26 | 4.72 | 0.00 | 0.00 | 5.66 | 100 |
| 30 | 75.93 | 12.04 | 4.83 | 0.00 | 0.00 | 7.41 | 100 |
| 31 | 74.55 | 11.82 | 4.55 | 0.00 | 0.00 | 9.09 | 100 |
| 32 | 73.21 | 11.61 | 4.46 | 0.00 | 0.00 | 10.71 | 100 |
| 33 | 80.19 | 12.26 | 0.94 | 0.00 | 0.94 | 5.66 | 100 |
| 34 | 78.70 | 12.04 | 0.93 | 0.00 | 0.93 | 7.41 | 100 |
| 35 | 77.78 | 12.04 | 0.93 | 1.85 | 0.00 | 7.41 | 100 |
| 36 | 75.45 | 11.82 | 0.91 | 2.73 | 0.00 | 9.09 | 100 |

In Table 2 below, raw materials having lead content are presented as comparative materials.

TABLE 2
(All data is in weight percent)

| Example | | | | | | | |
|---|---|---|---|---|---|---|---|
| No. | Cu | Sn | Bi | MoS₂ | CuP | Graphite | Total |
| 37 | 78.30 | 12.26 | 2.83 | 0.00 | 0.94 | 5.66 | 100 |
| 38 | 77.78 | 12.04 | 1.85 | 0.00 | 0.,93 | 7.41 | 100 |
| 39 | 76.85 | 12.04 | 1.85 | 1.85 | 0.00 | 7.41 | 100 |
| 40 | 74.55 | 11.82 | 1.82 | 2.73 | 0.00 | 9.09 | 100 |

Comparative experiments were carried out with selected examples.

### Friction and Wear Comparative Experiments

Tribilogy test-bench for oscillating, rotating motions

| Parameter: | |
|---|---|
| Unit stress | 10 MPa |
| Sliding velocity | 0.008 m/s |
| Counteractive substance | steel with material designation 1.2080 |
| Angular motion | ±17.5 (total angle for cycle 70°) |
| Test piece | cylindrical bearing shell |
| | inner diameter 100 mm |
| | outer diameter 130 mm |
| | length 50 mm |

### Wear Experiments

Tribilogy test-bench for rotating motions

| | |
|---|---|
| Stress | 2000 N |
| Velocity | 0.05 m/s |
| Counteractive substance | steel with material designation C45 |
| Rotary motion | 360° |
| Test piece | cylindrical pin with 20 mm diameter and |
| | 40 mm length |

In FIGS. 1-3 the compressive strength and hardness for a lead-base alloy and an alloy according to the invention are shown. The number of the alloy according to the invention correlates with the numbering in the table. For alloys of the invention, in each case four experiments were performed. It is clear

to see, that the compressive strength and the hardness could be increased relative to the standard values for the lead-containing raw materials.

In FIGS. 4-11 the oxidation behavior of two plain-bearing materials according to the invention is shown in comparison to a lead-containing bearing material. The oxidation behavior manifests itself in changes of length, which, on the other hand, is of significance for dimensional stability in operation. It is evident that the tested raw materials do not differ from one another in regard to oxidation behavior.

In FIGS. 12-15 the coefficients of friction, the wear and the wear rate for two plain-bearing materials according to the invention are shown in comparison to a lead-containing raw material are shown. It is clear to see, that with substitution of lead by bismuth the coefficient of friction slightly declines. With reduction of the bismuth content, increases are noticeable in the coefficient of friction as well as in the wear.

In FIGS. 16-19 wear tests are shown, whereby the weight loss and the wear rate in each case for two plain-bearing materials according to the invention are presented in comparison to a lead-containing plain-bearing material. It is evident that with partial substitution of lead by bismuth considerably better wear values result. This also indicates that a decrease of bismuth content leads to higher abrasion values. From the tribological point of view, the preferred bismuth content appears to represent an optimum.

1. Sintered dry plain-bearing material made of a copper alloy, comprising:
10 to 15% by weight tin
0.5 to 10% by weight bismuth
5 to 12% by weight graphite
copper as the remainder,
wherein the tin content is greater than the bismuth content.

2. Plain-bearing material according to claim 1, wherein, the bismuth content amounts to 0.8 up to less than 5% by weight.

3. Plain-bearing material according to claim 1, wherein, the bismuth content amounts to 8 up to 10% by weight.

4. Plain-bearing material according to claim 1, wherein the tin content amounts to greater than 10 up to 13% by weight.

5. Plain-bearing material according to claim 1, wherein the tin content amounts to 11 up to 13% by weight.

6. Plain-bearing material according to claim 1, wherein the graphite content amounts to 5.66 up to 10.71% by weight.

7. Plain-bearing material according to claim 1, wherein the graphite is natural graphite.

8. Plain-bearing material according to claim 1, wherein the graphite is synthetic graphite.

9. Plain-bearing material according to claim 1, wherein the graphite has a grain size range with 99% less than 40 μm.

10. Plain-bearing material according to claim 1, wherein the graphite has a grain size range of 100 to 600 μm.

11. Plain-bearing material according to claim 10, wherein the graphite has a grain size range of 100 to 300 μm.

12. Plain-bearing material according to claim 11, wherein the material contains at least one additional sintering auxiliary.

13. Plain-bearing material according to claim 12, wherein the at least one additional sintering auxiliary consists of 1 to 3% by weight MoS2 and/or 0.5 to 2% by weight CuP.

14. Plain-bearing material according to claim 12, including a support material made from steel and/or bronze, upon which the plain-bearing material is sintered.

15-17. (canceled)
